(19) United States
(12) Patent Application Publication
(10) Pub. No.: US 2014/0049554 A1
(43) Pub. Date: Feb. 20, 2014

(54) METHOD OF MANIPULATING CHARACTER STRING IN EMBEDED SYSTEM

(71) Applicant: ARPHIC TECHNOLOGY CO., LTD., New Taipei City (TW)

(72) Inventors: Wan-Chih Chen, Taipei City (TW); Wen-Kae Tsao, Taipei City (TW)

(73) Assignee: ARPHIC TECHNOLOGY CO., LTD., New Taipei City (TW)

(21) Appl. No.: 13/624,976

(22) Filed: Sep. 24, 2012

(30) Foreign Application Priority Data
Aug. 15, 2012 (TW) 101129474

(51) Int. Cl. G09G 5/02

(52) U.S. Cl. 345/589

(57) ABSTRACT

A special encoded string is generated according to character codes and attributes and/or colors of a plurality of characters in an original string. An alternate encoded string is generated according to the special encoded string. A layout string is generated by laying out a plurality of characters in the alternate encoded string. Then glyphs having attributes and/or colors of a plurality of characters in the layout string are rendered, and the glyphs having the attributes and/or the colors of the plurality characters of the layout string are shown on a display.

### BACKGROUND OF THE INVENTION

1. Field of the Invention

The present invention is related to a method of manipulating a character string in embedded system, and more particularly to a method of laying out a character string of complex text languages in the embedded system.

2. Description of the Prior Art

A variety of languages such as, inter alia, Thai language, Khmer language, Myanmar language, Hindi language, Bengali language, Tamil language, belong to complex text languages. Characters of these languages are written from left to right. A font engine is unable to correctly render strings containing characters of these languages because vowels and consonants of these languages are combined in a complex way, and the displayed order of the characters is not the same as the logical order. Aside from that, languages such as, inter alia, Arabic language, Farsi language, and Hebrew language also belong to complex text languages, while characters of these languages are written from right to left. Thus a complex text layout engine employed with a bi-directional text layout function is needed for correctly formatting characters and laying out a string containing mixed characters of complex text languages written from left to right and that written from right to left. For example, a character may have to be laid out as a prefix or a suffix of other characters of a complex text language.

The complex text layout engine can also be used to layout a plaintext string containing, inter alia, Chinese language, Japanese language, Korean language, English language, and/or a European language.

The text layout engine in the embedded system can layout a plaintext string in which characters are encoded in 2 byte Unicode. However due to limited memory spaces and limited operation efficiency of the embedded system compared with a personal computer, the text layout engine in the embedded system is unable to layout a string in which characters are encoded in 4 byte Unicode, and/or to layout a string in which characters have attributes or colors. Thus characters and strings in a document file in the embedded system may be displayed incorrectly.

### SUMMARY OF THE INVENTION

An embodiment of the present invention discloses a character string manipulation method used in embedded system. The method includes generating a special encoded string according to character codes and attributes and/or colors of a plurality of characters in an original string. Generate an alternate encoded string according to the special encoded string using a special encoding and attribute processing module in the embedded system. Generate a layout string by laying out a plurality of characters in the alternate encoded string using a layout engine in the embedded system. Render glyphs having attributes and/or colors of a plurality of characters in the layout string using a font engine in the embedded system. The glyphs having the attributes and/or the colors of the plurality characters are displayed in the layout string on a display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a character string manipulation method according to an embodiment of the present invention.

FIG. 2 is a diagram illustrating modules in embedded system for executing the method of FIG. 1 according to an embodiment of the present invention.

FIG. 3 is a character string according to an embodiment of the present invention.

FIG. 4 is a character string according to another embodiment of the present invention.

FIG. 5 is a character string according to another embodiment of the present invention.

FIG. 6 is a character string according to another embodiment of the present invention.

FIG. 7 is a character string according to another embodiment of the present invention.

FIG. 8 is a character string according to another embodiment of the present invention.

FIG. 9 is a character string according to another embodiment of the present invention.

### DETAILED DESCRIPTION

A method used in embedded system for laying out a character string containing characters each having 2 byte character code and an attribute and/or a color is introduced in the present invention. The method may also be used for laying out a string containing characters of complex text languages and having attributes and/or colors. The method of the present invention may also be used to handle characters each having 4 byte character code with its Unicode value bigger than 65535 and cannot be represented by 2 byte Unicode, such as characters belonging to Unicode Extension B or Unicode Emoticons. The attribute may be encoded in 2 bytes or in 4 bytes, for example, when the attribute is encoded in 2 bytes, 0×0100 may represent italic, 0×0200 may represent boldface, 0×0400 may represent underline, and 0×0800 may represent outline. The color may be encoded in 2 bytes or 4 bytes, for example, when the color is encoded in 4 bytes, 0×00CCFF80 may represent a character having a green level of 0×00, a red level of 0×CC, a transparent level of 0×FF, and a blue level of 0x80, whereas 0×FFFFFFFF may represent a character of white color.

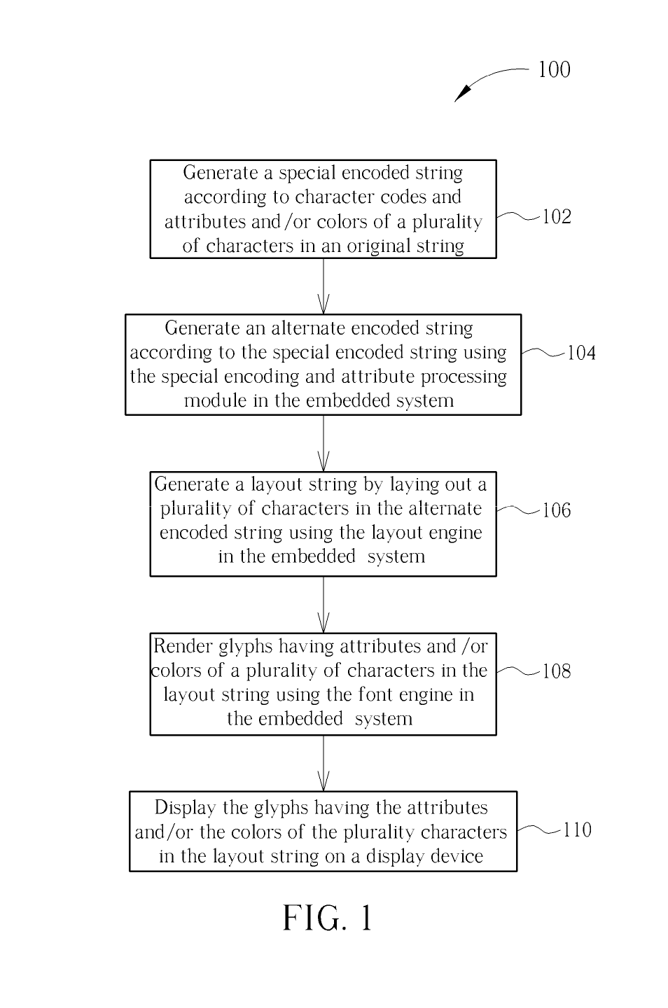

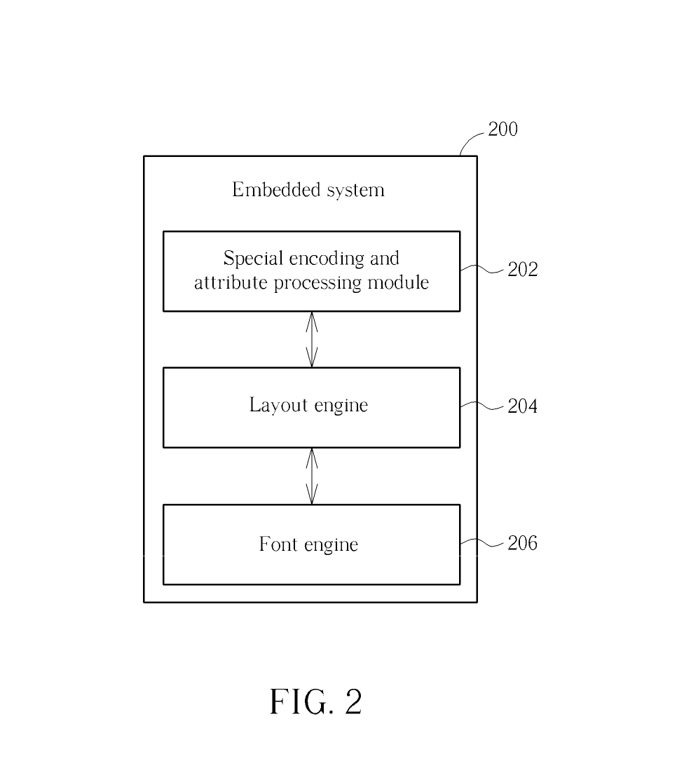

Please refer to FIG. 1 and FIG. 2. FIG. 1 is a flowchart illustrating a character string manipulation method 100 according to an embodiment of the present invention. FIG. 2 is a diagram illustrating modules in embedded system 200 for executing method 100 according to an embodiment of the present invention. The embedded system 200 may include a special encoding and attribute processing module 202, a layout engine 204, and a font engine 206. In another embodiment, the layout engine 204 may be replaced by a complex text layout engine. The method 100 may include the following steps.

Step 102: Generate a special encoded string according to character codes and attributes and/or colors of a plurality of characters in an original string.

Step 104: Generate an alternate encoded string according to the special encoded string using the special encoding and attribute processing module 202 in the embedded system 200.

Step 106: Generate a layout string by laying out a plurality of characters in the alternate encoded string using the layout engine 204 in the embedded system 200.

Step 108: Render glyphs having attributes and/or colors of a plurality of characters in the layout string using the font engine 206 in the embedded system 200.

Step 110: Display the glyphs having the attributes and/or the colors of the plurality characters in the layout string on a display device.

An encoding module maybe employed in step 102 to generate the special encoded string according to the character codes and the attributes and/or the colors of the plurality of characters in the original string. In step 102, each character code of the plurality of characters in the original string may be 2 byte Unicode or 4 byte Unicode. In the present invention, “U+” is followed by numerals to indicate the Unicode code point of a character, and Unicode transformation formats may be UTF-8, UTF-16 or UTF-32. For example, 2 byte Unicode of the original string “ABC” having no attribute and color may be represented as U+0041 U+0042 U+0043 that respectively correspond to Unicode 0041 of the character A, Unicode 0042 of the character B, and Unicode 0043 of the character C.

Plural predefined special attribute encoding modes may be utilized in step 102 so as to convert the character codes of the plurality of characters in the original string from 4 bytes to 2 bytes when the original string contains characters of Unicode code point bigger than 65535 and/or having the attributes and/or the colors. Examples of the plural predefined special attribute encoding modes are listed as following.

Encoding mode 1: Utilized when the character codes of the plurality of characters in the original string are 2 byte Unicode and the attributes of the plurality of characters in the original string are encoded in 2 bytes.

Encoding mode 2: Utilized when the character codes of the plurality of characters in the original string are 2 byte Unicode, the attributes of the plurality of characters in the original string are encoded in 2 bytes, and the colors of the plurality of characters in the original string are encoded in 4 bytes.

Encoding mode 3: Utilized when the character codes of the plurality of characters in the original string are 2 byte Unicode and the colors of the plurality of characters in the original string are encoded in 4 bytes.

Encoding mode 4: Utilized when the character codes of the plurality of characters in the original string are 4 byte Unicode.

Encoding mode 5: Utilized when the character codes of the plurality of characters in the original string are 4 byte Unicode and the attributes of the plurality of characters in the original string are encoded in 2 bytes.

Encoding mode 6: Utilized when the character codes of the plurality of characters in the original string are 4 byte Unicode, the attributes of the plurality of characters in the original string are encoded in 2 bytes, and the colors of the plurality of characters in the original string are encoded in 4 bytes.

Encoding mode 7: Utilized when the character codes of the plurality of characters in the original string are 4 byte Unicode and the colors of the plurality of characters in the original string are encoded in 4 bytes.

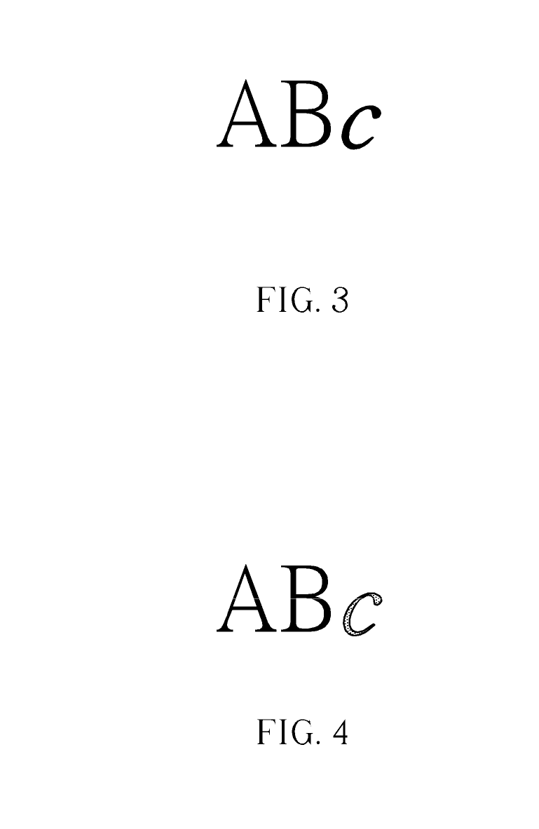

In an embodiment utilizing the encoding mode 1, an original string of FIG. 3 having attributes is outputted or displayed after being laid out in the embedded system 200. Two byte Unicode of the original string of FIG. 3 is U+0041 U+0042 U+0043. First, a user may define a predefined attribute in a special attribute lookup table in the encoding module using an application program. For example, the predefined attribute maybe defined as font size 26, represented as “0000 001A”. In this embodiment, character codes of first two characters of the original string of FIG. 3 are U+0041 and U+0042, belonging to Unicode plane 0 (Unicode value smaller than 0×10000), and attributes of the first two characters are the same as the predefined attribute, thus the first two characters are not special characters and are encoded as their original 2 byte Unicode 0041 0042 respectively by the encoding module. A character code of a third character of the original string of FIG. 3 is U+0043 and an attribute of the third character is font size 16, boldface, and italic, which is not the same as the predefined attribute, thus the third character is a special character and is encoded as a 2 byte special code for representing the character code and the attribute of the third character by the encoding module. For example, the 2 byte special code may be F701 for representing 0043 0310, where 0043 is original 2 byte Unicode of the third character and 0310 is the attribute of the third character. The string 0043 0310 is then stored in the special attribute lookup table so as to reversely lookup the original 2 byte Unicode and the attribute of the third character via the 2 byte special code. Next, the encoding module generates a special encoded string having coded data of 0041 0042 F701 0000 F8FF 0001 0001 0000 001A 0043 0310. Following is an explanation of the coded data from left to right. The string 0041 0042 F701 represents the original 2 byte Unicode of the first two characters and the 2 byte special code of the third character, 0000 represents an end of the original string, F8FF represents an identification code used in the special attribute lookup table, 0001 represents the encoding mode 1, 0001 represents number of special characters in the original string, 0000 001A represents the predefined attribute, and 0043 0310 represents the original 2 byte Unicode and the attribute of the special character. For all embodiments of the present invention, data of the identification code used in the special attribute lookup table, the encoding mode, number of the special characters, and the predefined attribute may all be omitted, or at least one of the said data may be omitted in the coded data.

In step 104, the special encoding and attribute processing module 202 may substitute the original 2 byte Unicode of the special character for the special code representing the attribute of the special character in the special encoded string after receiving the special encoded string. For example, 0043 is substituted for F701 in this embodiment to generate an alternate encoded string to be sent to and laid out by the layout engine 204 as in step 106. After laying out the alternate encoded string, the layout engine 204 compares characters in the layout string and characters in the special encoded string one by one, so as to convert the character codes and the attributes of same characters not represented by special codes in the layout string and in the special encoded string to the original 2 byte Unicode of these characters and the predefined attribute respectively, whereas the character code and the attribute of the special character represented by the special code are converted to the original 2 byte Unicode and the attribute of the special character by looking up the special attribute lookup table. Then the original 2 byte Unicode of each character in the layout string is transmitted to the font engine 206 to perform step 108 and step 110 for rendering and displaying glyphs respectively according to the character codes and the attributes and/or the colors of the plurality of characters in the layout string.

In an embodiment utilizing the encoding mode 2, an original string of FIG. 4 having attributes and colors is outputted after being laid out in the embedded system 200. Two byte Unicode of the original string of FIG. 4 is U+0041 U+0042 U+0043. First, a predefined attribute and a predefined color may be defined in the special attribute lookup table in the encoding module. For example, the predefined attribute may be defined as font size 26 and the predefined color may be defined as black and opaque, represented as “0000 001A 0000 FF00”. In this embodiment, character codes of first two characters of the original string of FIG. 4 are U+0041 and U+0042, belonging to Unicode plane 0, and attributes and colors of the first two characters are the same as the predefined attribute and the predefined color, thus the first two characters are not special characters and are encoded as their original 2 byte Unicode 0041 0042 respectively by the encoding module. A character code of a third character of the original string of FIG. 4 is U+0043, an attribute of the third character is font size 16, boldface, and italic, and a color of the third character is red and opaque (indicated by dotted area), which are not the same as the predefined attribute and the predefined color, thus the third character is a special character and is encoded as a 2 byte special code for representing the character code, the attribute, and the color of the third character by the encoding module. For example, the 2 byte special code may be F701 for representing 0043 0310 00FF FF00, where 0043 is original 2 byte Unicode of the third character, 0310 is the attribute of the third character (font size 16, boldface, and italic), and 00FF FF00 is the color of the third character (red and opaque). The string 0043 0310 00FF FF00 is then stored in the special attribute lookup table so as to reversely lookup the original 2 byte Unicode, the attribute, and the color of the third character via the 2 byte special code. For all embodiments in the present invention, special codes representing different characters, different attributes, and different colors are not repeated. Next, the encoding module generates a special encoded string having coded data of 0041 0042 F701 0000 F8FF 0002 0001 0000 001A 0000 FF00 0043 0310 00FF FF00.

Following is an explanation of the coded data from left to right. The string 0041 0042 F701 represents the original 2 byte Unicode of the first two characters and the 2 byte special code of the third character, 0000 represents an end of the original string, F8FF represents an identification code used in the special attribute lookup table, 0002 represents the encoding mode 2, 0001 represents number of special characters in the original string, 0000 001A 0000 FF00 represents the predefined attribute and the predefined color, and 0043 0310 00FF FF00 represents the original 2 byte Unicode, the attribute, and the color of the special character.

In step 104, the special encoding and attribute processing module 202 may substitute the original 2 byte Unicode of the special character for the special code representing the attribute and the color of the special character in the special encoded string after receiving the special encoded string. For example, 0043 is substituted for F701 in this embodiment to generate an alternate encoded string to be sent to and laid out by the layout engine 204 as in step 106. After laying out the alternate encoded string, the layout engine 204 compares characters in the layout string and characters in the special encoded string one by one, so as to convert the character codes, the attributes, and the colors of same characters not represented by special codes in the layout string and in the special encoded string to the original 2 byte Unicode of these characters, the predefined attribute, and the predefined color respectively, whereas the character code, the attribute and the color of the special character represented by the special code are converted to the original 2 byte Unicode, the attribute, and the color of the special character by looking up the special attribute lookup table. Then the original 2 byte Unicode of each character in the layout string is transmitted to the font engine 206 to perform step 108 and step 110.

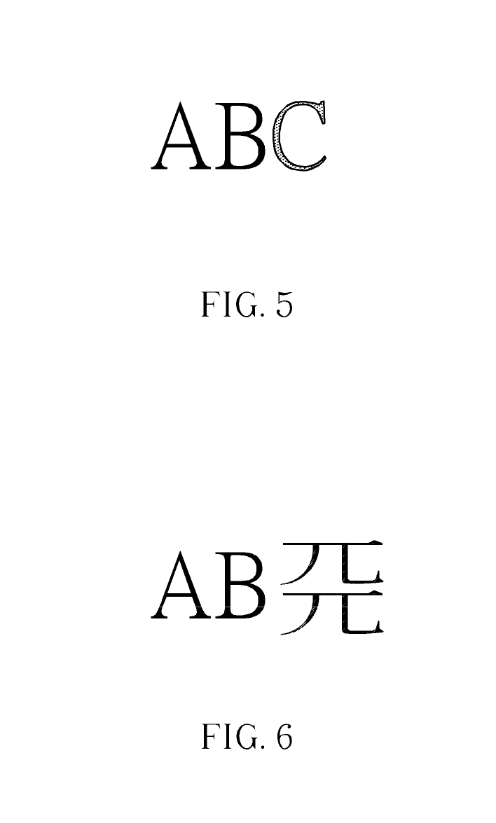

In an embodiment utilizing the encoding mode 3, an original string of FIG. 5 having colors is outputted after being laid out in the embedded system 200. Two byte Unicode of the original string of FIG. 5 is U+0041 U+0042 U+0043. First, a predefined color may be defined in the special attribute lookup table in the encoding module. For example, the predefined color may be defined as black and opaque, represented as “0000 0000 FF00”. In this embodiment, character codes of first two characters of the original string of FIG. 5 are U+0041 and U+0042, belonging to Unicode plane 0, and colors of the first two characters are the same as the predefined color, thus the first two characters are not special characters and are encoded as their original 2 byte Unicode 0041 0042 respectively by the encoding module. A character code of a third character of the original string of FIG. 5 is U+0043 and a color of the third character is red and opaque (indicated by dotted area), which is not the same as the predefined color, thus the third character is a special character and is encoded as a 2 byte special code for representing the character code and the color of the third character by the encoding module. For example, the 2 byte special code may be F701 for representing 0043 00FF FF00, where 0043 is original 2 byte Unicode of the third character and 00FF FF00 is the color of the third character (red and opaque). The string 0043 00FF FF00 is then stored in the special attribute lookup table so as to reversely lookup the original 2 byte Unicode and the color of the third character via the 2 byte special code. Next, the encoding module generates a special encoded string having coded data of 0041 0042 F701 0000 F8FF 0003 0001 0000 0000 FF00 0043 00FF FF00. Following is an explanation of the coded data from left to right. The string 0041 0042 F701 represents the original 2 byte Unicode of the first two characters and the 2 byte special code of the third character, 0000 represents an end of the original string, F8FF represents an identification code used in the special attribute lookup table, 0003 represents the encoding mode 3, 0001 represents number of special characters in the original string, 0000 0000 FF00 represents the predefined color, and 0043 00FF FF00 represents the original 2 byte Unicode and the color of the special character.

In step 104, the special encoding and attribute processing module 202 may substitute the original 2 byte Unicode of the special character for the special code representing the color of the special character in the special encoded string after receiving the special encoded string. For example, 0043 is substituted for F701 in this embodiment to generate an alternate encoded string to be sent to and laid out by the layout engine 204 as in step 106. After laying out the alternate encoded string, the layout engine 204 compares characters in the layout string and characters in the special encoded string one by one, so as to convert the character codes and the colors of same characters not represented by special codes in the layout string and in the special encoded string to the original 2 byte Unicode of these characters and the predefined color respectively, whereas the character code and the color of the special character represented by the special code are converted to the original 2 byte Unicode and the color of the special character by looking up the special attribute lookup table. Then the original 2 byte Unicode of each character in the layout string is transmitted to the font engine 206 to perform step 108 and step 110.

In an embodiment utilizing the encoding mode 4, an original string of FIG. 6 containing a character of complex text language is outputted after being laid out in the embedded system 200. Four byte Unicode of the original string of FIG. 6 is U+00000041 U+00000042 U+00020018. In this embodiment, character codes of first two characters of the original string of FIG. 6 are U+00000041 and U+00000042, belonging to Unicode plane 0, thus the first two characters are not special characters and are encoded as 2 byte Unicode 0041 0042 respectively by the encoding module. A character code of a third character of the original string of FIG. 6 is U+00020018, belonging to Unicode plane 2, thus the third character is a special character and is encoded as a 2 byte special code for representing the character code of the third character by the encoding module. For example, the 2 byte special code may be F701 for representing 0018 0002 (arranged by how U+00020018 is stored in a memory). The string 0018 0002 is then stored in the special attribute lookup table so as to reversely lookup the original 4 byte Unicode of the third character via the 2 byte special code. Next, the encoding module generates a special encoded string having coded data of 0041 0042 F701 0000 F8FF 0004 0001 0018 0002. Following is an explanation of the coded data from left to right . The string 0041 0042 F701 represents the 2 byte Unicode of the first two characters and the 2 byte special code of the third character, 0000 represents an end of the original string, F8FF represents an identification code used in the special attribute lookup table, 0004 represents the encoding mode 4, 0001 represents number of special characters in the original string, 0018 0002 represents the original 4 byte Unicode of the special character.

In step 104, the special encoding and attribute processing module 202 may substitute a 2 byte Unicode capable of representing another character of the same complex text language as the special character for the special code representing the special character in the special encoded string after receiving the special encoded string. For example, 2 byte Unicode U+4E00 representing another Chinese character may be substituted for F701 in this embodiment so that the layout engine 204 may layout the special character of complex text language in a string according to text directionalities of the corresponding complex text language. Otherwise, a 2 byte Unicode capable of representing another character of a complex text language having the same text directionalities, which may be from left to right or from right to left, as the special character may be substituted for the special code representing the special character in the special encoded string. Otherwise, a 2 byte Unicode capable of representing another character regardless of its language may be substituted for the special code representing the special character in the special encoded string. Next an alternate encoded string is generated and sent to the layout engine 204 in step 106. In so doing, formatting characters of complex text language in a string and laying out a string having characters of complex text language bi-directionally, either from left to right or from right to left, may be performed in the most efficient way. After laying out the alternate encoded string, the layout engine 204 compares characters in the layout string and characters in the special encoded string one by one, so as to convert the character codes of same characters not represented by special codes in the layout string and in the special encoded string to the original 4 byte Unicode of these characters respectively, whereas the character code of the special character represented by the special code is converted to the original 4 byte Unicode of the special character by looking up the special attribute lookup table. Then the original 4 byte Unicode of each character in the layout string is transmitted to the font engine 206 to perform step 108 and step 110.

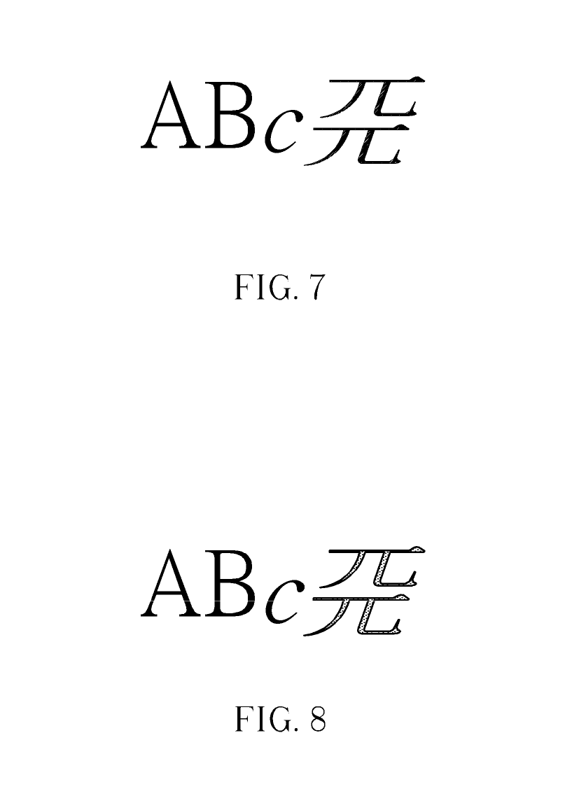

In an embodiment utilizing the encoding mode 5, an original string of FIG. 7 having attributes and containing a character of complex text language is outputted after being laid out in the embedded system 200. Four byte Unicode of the original string of FIG. 7 is U+00000041 U+00000042 U+00000043 U+00020018. First, a predefined attribute may be defined in the special attribute lookup table in the encoding module. For example, the predefined attribute may be defined as font size 26, represented as “0000 0000 001A”. In this embodiment, character codes of first two characters of the original string of FIG. 7 are U+00000041 and U+00000042, belonging to Unicode plane 0, and attributes of the first two characters are the same as the predefined attribute, thus the first two characters are not special characters and are encoded as 2 byte Unicode 0041 0042 respectively by the encoding module. A character code of a third character of the original string of FIG. 7 is U+00000043 and an attribute of the third character is font size 16, boldface, and italic, which is not the same as the predefined attribute, thus the third character is a special character and is encoded as a 2 byte special code for representing the character code and the attribute of the third character by the encoding module. For example, the 2 byte special code may be F701 for representing 0043 0000 0310, where 0043 0000 is original 4 byte Unicode of the third character and 0310 is the attribute of the third character. The string 0043 0000 0310 is then stored in the special attribute lookup table. A character code of a fourth character of the original string of FIG. 7 is U+00020018, belonging to Unicode plane 2, and an attribute of the fourth character is font size 26, boldface, and italic, which is not the same as the predefined attribute, thus the fourth character is a special character and is encoded as a 2 byte special code for representing the character code and the attribute of the fourth character by the encoding module. For example, the 2 byte special code may be F702 for representing 0018 0002 031A, where 0018 0002 is original 4 byte Unicode of the fourth character and 031A is the attribute of the fourth character. The string 0018 0002 031A is then stored in the special attribute lookup table so as to reversely lookup the original 4 byte Unicode and the attribute of the fourth character via the 2 byte special code. Next, the encoding module generates a special encoded string having coded data of 0041 0042 F701 F702 0000 F8FF 0005 0002 0000 0000 001A 0043 0000 0310 0018 0002 0310. Following is an explanation of the coded data from left to right. The string 0041 0042 F701 F702 represents the 2 byte Unicode of the first two characters and the 2 byte special codes of the third character and the fourth character, 0000 represents an end of the original string, F8FF represents an identification code used in the special attribute lookup table, 0005 represents the encoding mode 5, 0002 represents number of special characters in the original string, 0000 0000 001A represents the predefined attribute, 0043 0000 0310 represents the original 4 byte Unicode and the attribute of the third character, 0018 0002 031A represents the original 4 byte Unicode and the attribute of the fourth character.

In step 104, the special encoding and attribute processing module 202 may substitute a 2 byte Unicode of the special character for the special code representing the attribute of the special character in the special encoded string after receiving the special encoded string. For example, 2 byte Unicode 0043 is substituted for the special code F701. The special encoding and attribute processing module 202 may substitute a 2 byte Unicode capable of representing another character of the same complex text language as the fourth character for the special code representing the fourth character in the special encoded string after receiving the special encoded string. For example, 2 byte Unicode U+4E00 representing another Chinese character may be substituted for F702 in this embodiment so that the layout engine 204 may lay out the special character of complex text language in a string according to text directionalities of the corresponding complex text language. Otherwise, a 2 byte Unicode capable of representing another character of a complex text language having the same text directionalities, which may be from left to right or from right to left, as the fourth character may be substituted for the special code representing the fourth character in the special encoded string. Otherwise, a 2 byte Unicode capable of representing another character regardless of its language may be substituted for the special code representing the fourth character in the special encoded string. Next an alternate encoded string is generated and sent to the layout engine 204 in step 106. After laying out the alternate encoded string, the layout engine 204 compares characters in the layout string and characters in the special encoded string one by one, so as to convert the character codes of same characters not represented by special codes in the layout string and in the special encoded string to the original Unicode of these characters respectively, whereas the attributes and the character codes of the special characters represented by the special codes are converted to the original 4 byte Unicode of the special characters respectively by looking up the special attribute lookup table. Then the original 4 byte Unicode of each character in the layout string is transmitted to the font engine 206 to perform step 108 and step 110.

In an embodiment utilizing the encoding mode 6, an original string of FIG. 8 having attributes and colors, and containing a character of complex text language is outputted after being laid out in the embedded system 200. Four byte Unicode of the original string of FIG. 8 is U+00000041 U+00000042 U+00000043 U+00020018. First, a predefined attribute and a predefined color may be defined in the special attribute lookup table in the encoding module. For example, the predefined attribute may be defined as font size 26 and the predefined color may be defined as black and opaque, represented as “0000 0000 001A 0000 FF00”. In this embodiment, character codes of first two characters of the original string of FIG. 8 are U+00000041 and U+00000042, belonging to Unicode plane 0, and attributes and colors of the first two characters are the same as the predefined attribute and the predefined color, thus the first two characters are not special characters and are encoded as 2 byte Unicode 0041 0042 respectively by the encoding module. A character code of a third character of the original string of FIG. 8 is U+00000043 and an attribute of the third character is font size 16, boldface, and italic, which is not the same as the predefined attribute, and a color of the third character is black and opaque, thus the third character is a special character and is encoded as a 2 byte special code for representing the character code, the attribute, and the color of the third character by the encoding module. For example, the 2 byte special code may be F701 for representing 0043 0000 0310 0000 FF00, where 0043 0000 is original 4 byte Unicode of the third character, 0310 is the attribute of the third character, and 0000 FF00 is the color of the third character. The string 0043 0000 0310 0000 FF00 is then stored in the special attribute lookup table. A character code of a fourth character of the original string of FIG. 8 is U+00020018, belonging to Unicode plane 2, and an attribute of the fourth character is font size 26, boldface, and italic, and a color of the fourth character is red and opaque (indicated by dotted area), which are not the same as the predefined attribute and the predefined color, thus the fourth character is a special character and is encoded as a 2 byte special code for representing the character code, the attribute, and the color of the fourth character by the encoding module. For example, the 2 byte special code may be F702 for representing 0018 0002 031A 00FF FF00, where 0018 0002 is original 4 byte Unicode of the fourth character, 031A is the attribute of the fourth character, and 00FF FF00 is the color of the fourth character. The string 0018 0002 031A 00FF FF00 is then stored in the special attribute lookup table so as to reversely lookup the original 4 byte Unicode, the attribute, and the color of the fourth character via the 2 byte special code. Next, the encoding module generates a special encoded string having coded data of 0041 0042 F701 F702 0000 F8FF 0006 0002 0000 0000 001A 0000 FF00 0043 0000 0310 0000 FF00 0018 0002 031A 00FF FF00. Following is an explanation of the coded data from left to right. The string 0041 0042 F701 F702 represents the 2 byte Unicode of the first two characters and the 2 byte special codes of the third character and the fourth character, 0000 represents an end of the original string, F8FF represents an identification code used in the special attribute lookup table, 0006 represents the encoding mode 6, 0002 represents number of special characters in the original string, 0000 0000 001A represents the predefined attribute, 0000 FF00 represents the predefined color, 0043 0000 0310 0000 FF00 represents the original 4 byte Unicode, the attribute, and the color of the third character, 0018 0002 031A 00FF FF00 represents the original 4 byte Unicode, the attribute, and the color of the fourth character.

In step 104, after receiving the special encoded string, the special encoding and attribute processing module 202 performs the same procedure as the previous embodiment. Then the original Unicode of each character in the layout string is transmitted to the font engine 206 to perform step 108 and step 110.

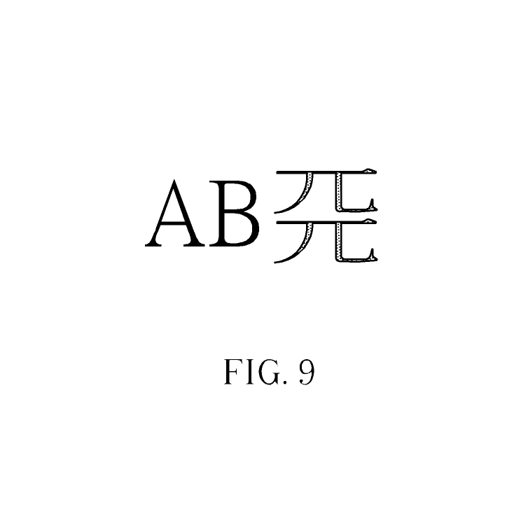

In an embodiment utilizing the encoding mode 7, an original string of FIG. 9 having colors and containing a character of complex text language is outputted after being laid out in the embedded system 200. Four byte Unicode of the original string of FIG. 9 is U+00000041 U+00000042 U+00020018. First, a predefined color may be defined in the special attribute lookup table in the encoding module. For example, the predefined color maybe defined as black and opaque, represented as “0000 0000 0000 FF00”. In this embodiment, character codes of first two characters of the original string of FIG. 9 are U+00000041 and U+00000042, belonging to Unicode plane 0, and colors of the first two characters are the same as the predefined color, thus the first two characters are not special characters and are encoded as 2 byte Unicode 0041 0042 respectively by the encoding module. A character code of a third character of the original string of FIG. 9 is U+00020018, belonging to Unicode plane 2, and a color of the third character is red and opaque (indicated by dotted area), which is not the same as the predefined color, thus the third character is a special character and is encoded as a 2 byte special code for representing the character code and the color of the third character by the encoding module. For example, the 2 byte special code may be F701 for representing 0018 0002 00FF FF00, where 0018 0002 is original 4 byte Unicode of the third character and 00FF FF00 is the color of the third character. The string 0018 0002 00FF FF00 is then stored in the special attribute lookup table so as to reversely lookup the original 4 byte Unicode and the color of the third character via the 2 byte special code. Next, the encoding module generates a special encoded string having coded data of 0041 0042 F701 0000 F8FF 0007 0001 0000 0000 0000 FF00 0018 0002 00FF FF00. Following is an explanation of the coded data from left to right. The string 0041 0042 F701 represents the 2 byte Unicode of the first two characters and the 2 byte special code of the third character, 0000 represents an end of the original string, F8FF represents an identification code used in the special attribute lookup table, 0007 represents the encoding mode 7, 0001 represents number of special characters in the original string, 0000 0000 0000 FF00 represents the predefined color, 0018 0002 00FF FF00 represents the original 4 byte Unicode and the color of the third character.

In step 104, after receiving the special encoded string, the special encoding and attribute processing module 202 performs the same procedure as the previous embodiment. Then the original Unicode of each character in the layout string is transmitted to the font engine 206 to perform step 108 and step 110.

In summary, character codes, attributes, and colors of characters may be stored in limited memory spaces in the embedded system 200 and the layout engine 204 for manipulating a string containing 2 byte Unicode characters in the embedded system 200 and may be utilized to perform bi-directional complex text layout function, format characters of complex text languages, and handle characters having attributes and colors. Thus a character string having attributes and colors, and containing characters of complex text language may be outputted or displayed correctly and clearly after being laid out in the embedded system 200 according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A character string manipulation method in embedded system, the method comprising:
generating a special encoded string according to character codes and attributes and/or colors of a plurality of characters in an original string;
generating an alternate encoded string according to the special encoded string using a special encoding and attribute processing module in the embedded system;
generating a layout string by laying out a plurality of characters in the alternate encoded string using a layout engine in the embedded system;
rendering glyphs having attributes and/or colors of a plurality of characters in the layout string using a font engine in the embedded system; and
displaying the glyphs having the attributes and/or the colors of the plurality characters in the layout string on a display device.

2. The method of claim 1 wherein each character code of the plurality of characters in the original string is 2 bytes or 4 bytes.

3. The method of claim 1 wherein generating the special encoded string comprises converting each character code of the plurality of characters in the original string from 4 bytes to 2 bytes.

4. The method of claim 1 wherein each attribute of the plurality of characters in the original string is encoded in 2 bytes or in 4 bytes.

5. The method of claim 1 wherein each color of the plurality of characters in the original string are encoded in 2 bytes or in 4 bytes.

6. The method of claim 1 wherein generating the special encoded string according to the character codes and the attributes and/or the colors of the plurality of characters in the original string comprises encoding the character codes and the attributes and/or the colors of the plurality of characters in the original string as a plurality of special codes respectively corresponding to the plurality of characters in the original string.

7. The method of claim 6 wherein each special code of the plurality of special codes is 2 bytes.

8. The method of claim 1 wherein rendering the glyphs having the attributes and/or the colors of the plurality of characters in the layout string using the font engine in the embedded system is rendering the glyphs respectively according to the character codes and the attributes and/or the colors of the plurality of characters in the layout string.

9. The method of claim 1 wherein the layout engine is a complex text layout engine.
